(19) United States
(12) Patent Application Publication
(10) Pub. No.: US 2015/0022636 A1
(43) Pub. Date: Jan. 22, 2015

(54) METHOD AND SYSTEM FOR VOICE CAPTURE USING FACE DETECTION IN NOISY ENVIRONMENTS

(71) Applicant: NVIDIA Corporation, Santa Clara, CA (US)

(72) Inventor: Guillermo SAVRANSKY, Mountain View, CA (US)

(73) Assignee: NVIDIA Corporation, Santa Clara, CA (US)

(21) Appl. No.: 13/946,383

(22) Filed: Jul. 19, 2013

(51) Int. Cl. G06K 9/00; H04R 3/00

(52) U.S. Cl. CPC G06K 9/00221; H04R 3/00
USPC 348/46

(57) ABSTRACT

Embodiments of the present invention are capable of determining a face direction associated with a detected subject (or multiple detected subjects) of interest within a 3D space using face detection procedures, while simultaneously avoiding the pick up of other environmental sounds. In addition, if more than one face is detected, embodiments of the present invention can automatically detect an active speaker based on the recognition of facial movements consistent with the performance of providing audio (e.g., tracking mouth movements) by those subjects whose faces were detected. Once determinations are made regarding face direction of the detected subject, embodiments of the present invention may dynamically adjust the audio acquisition capabilities of the audio capture device (e.g., microphone devices) relative to the location of the detected subject using beamforming techniques for instance. As such, embodiments of the present invention can detect the direction of the “talking object” and guide the audio subsystem to filter out any sound not coming from that direction.

### FIELD OF THE INVENTION

Embodiments of the present invention are generally related to the field of devices capable of directional audio signal receipt as well as image capture.

### BACKGROUND OF THE INVENTION

Beamforming technology enables devices to receive desired audio while simultaneously filtering out undesired background sounds. Conventional beamforming technologies utilize “audio beams” which are isolated audio channels that enhance the quality of sounds emanating from a particular direction. In forming these audio beams, conventional beamforming technologies generally focus on the distribution and/or arrangements of the microphones employed by the particular technology used (e.g., number, separation, relative position of the microphones).

Positioning of the audio beam is essential in capturing the most accurate audio possible. As a result of their focus on the physical characteristics of the microphones used, conventional beamforming technologies employed by modern systems provide less accuracy when determining audio beam position. These technologies are inefficient in the sense that they rely primarily on the volume gains or losses detected by the microphones employed by the system. As such, these inefficiencies may result in a greater amount of undesired noise acquired by the system and may ultimately lead to user frustration.

### SUMMARY OF THE INVENTION

Accordingly, a need exists to address the inefficiencies discussed above. What is needed is a system that enhances sound originating from a desired source while attenuating the pick up of sound from other sources in a mixed sound source environment (e.g., a “noisy environment”). Embodiments of the present invention are capable of determining a face direction associated with a detected subject (or multiple detected subjects) of interest within a 3D space using face detection procedures, while simultaneously avoiding the pick up of other environmental sounds. In addition, if more than one face is detected, embodiments of the present invention can automatically detect an active speaker based on the recognition of facial movements consistent with the performance of providing audio (e.g., tracking mouth movements) by those subjects whose faces were detected. Once determinations are made regarding face direction of the detected subject, embodiments of the present invention may dynamically adjust the audio acquisition capabilities of the audio capture device (e.g., microphone devices) relative to the location of the detected subject using beamforming techniques for instance. As such, embodiments of the present invention can detect the direction of the “talking object” and guide the audio subsystem to filter out any sound not coming from that direction.

More specifically, in one embodiment, the present invention is implemented as a method of audio signal acquisition. The method includes detecting a subject of interest within an environment using computer-implemented face detection procedures applied to image data captured by a camera system. In one embodiment, the method of detecting further includes automatically selecting an actively speaking subject as the subject of interest from a plurality of subjects of interest based on recorded images of facial movements performed by the actively speaking subject.

The method also includes determining a face direction associated with the subject of interest relative to the camera system within a 3 dimensional space using the image data associated with the subject. In one embodiment, the face direction comprises an angle and a depth. In one embodiment, the method of determining a face direction further includes using camera system focusing features to locate the subject of interest. In one embodiment, the method of determining a face direction further includes determining a 3 dimensional coordinate position for the subject of interest using stereoscopic cameras.

Additionally, the method includes producing an output audio signal using an audio capture arrangement by focusing an audio beam of the audio capture arrangement in the face direction, in which the output audio signal enhances audio originating from the subject of interest relative to other audio of the environment. In one embodiment, the audio capture arrangement comprises an array of microphones. In one embodiment, the method of focusing further includes electronically steering the audio beam to filter out directionally inapposite audio received relative to the face direction using beamforming procedures.

In one embodiment, the present invention is implemented as a system for audio signal acquisition. The system includes an image capture module operable to detect a subject of interest using computer-implemented face detection procedures applied to image data, in which the image capture module is operable to determine a face direction associated with the subject of interest relative to a camera system within a 3 dimensional space using image data associated with the subject of interest. In one embodiment, the image capture module is further operable to automatically select an actively speaking subject as the subject of interest from a plurality of subjects based on recorded images of facial movements performed by the actively speaking subject. In one embodiment, the face direction comprises an angle and a depth. In one embodiment, the image capture module is further operable to determine the depth using camera system focusing features to focus on the subject of interest. In one embodiment, the image capture module is further operable to determine a 3 dimensional coordinate position for the subject of interest using stereoscopic cameras.

The system also includes a directional audio capture arrangement operable to produce an output audio signal using a directional audio beam. In one embodiment, the directional audio capture arrangement is further operable to electronically steer the audio beam to filter out directionally inapposite audio received relative to the face direction using beamforming procedures. In one embodiment, the audio capture arrangement comprises an array of microphones. Furthermore, the system includes a beamforming module operable to direct the audio beam in the face direction in which the output audio signal enhances audio originating from the subject of interest relative to other audio.

In one embodiment, the present invention is implemented as a method of audio signal acquisition. The method includes detecting a plurality of subjects of interest using computer-implemented face detection procedures applied to image data. In one embodiment, the method of detecting further includes automatically selecting an actively speaking subject as the subject of interest based on recorded images of facial movements performed by the actively speaking subject. In one embodiment, the method of detecting further includes automatically detecting the plurality of subjects of interest using computer-implemented facial recognition procedures that recognize eye and nose positions. In one embodiment, the method of determining further includes using camera system focusing features to locate the plurality of subjects of interest.

The method also includes determining a respective face direction associated with each subject of the plurality of subjects relative to a camera system within a 3 dimensional space using the image data associated with the plurality of subjects of interest. In one embodiment, the method of determining further includes determining a respective 3 dimensional coordinate position for each subject of the plurality of subjects of interest using stereoscopic cameras.

Additionally, the method includes producing a respective output audio signal for each subject of the plurality of subjects of interest using a directional audio capture arrangement by focusing a plurality of audio beams in the face directions of the plurality of subjects of interest, in which the output audio signals enhance audio originating from the plurality of subjects of interest relative to other audio. In one embodiment, the audio capture arrangement comprises an array of microphones. In one embodiment, the method of focusing further includes electronically steering the plurality of audio beams to filter out directionally inapposite audio received relative to the respective face direction of each subject of the plurality of subjects of interest using beamforming procedures.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1A depicts an exemplary system in accordance with embodiments of the present invention.

FIG. 1B depicts an exemplary facial detection process in accordance with embodiments of the present invention.

FIG. 1C depicts an exemplary active speaker detection process in accordance with embodiments of the present invention.

FIG. 1D another exemplary active speaker detection process in accordance with embodiments of the present invention.

FIG. 1E depicts another exemplary face direction determination process in accordance with embodiments of the present invention.

FIG. 1F depicts an exemplary 3D full subject position determination process in accordance with embodiments of the present invention.

FIG. 2A is an illustration that depicts how a system determines a current audio signal direction relative to the system in accordance with embodiments of the present invention.

FIG. 2B is an illustration that depicts an exemplary audio beam positioning process in accordance with embodiments of the present invention.

FIG. 2C is another illustration that depicts an exemplary audio beam positioning process in accordance with embodiments of the present invention.

FIG. 3A illustrates yet another exemplary audio beam positioning process in accordance with embodiments of the present invention.

FIG. 3B illustrates yet another exemplary audio beam positioning process in accordance with embodiments of the present invention.

FIG. 4 is a flow chart that depicts an exemplary audio enhancing process in accordance with embodiments of the present invention.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

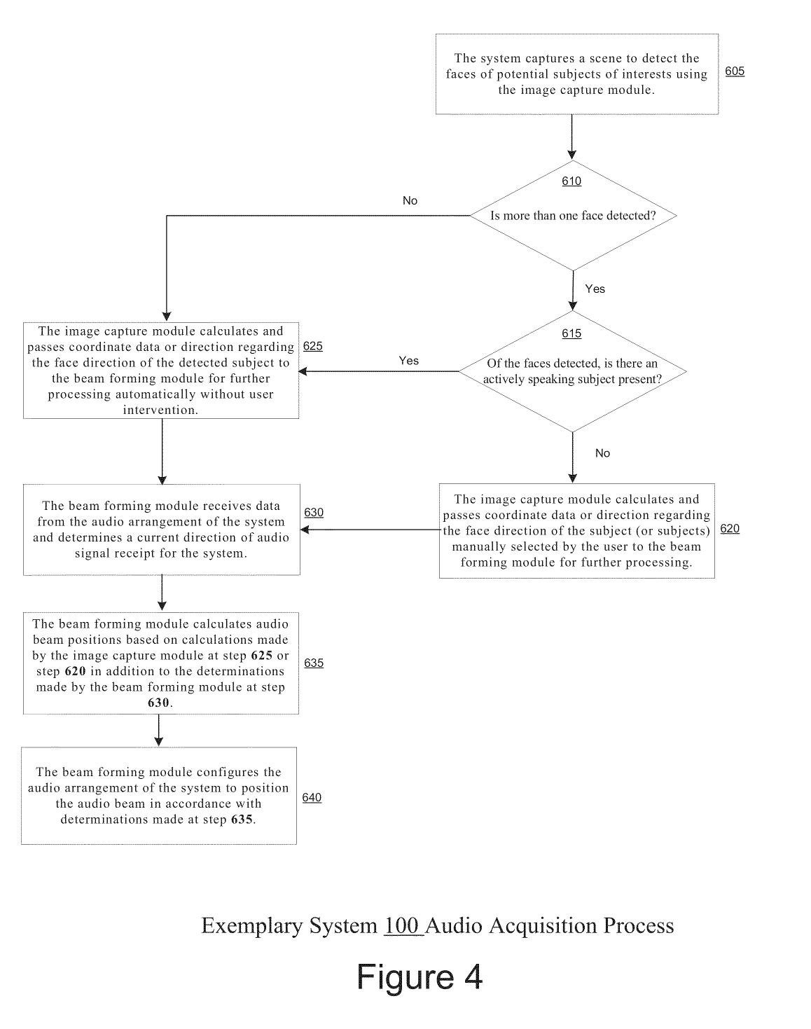

Portions of the detailed description that follow are presented and discussed in terms of a process. Although operations and sequencing thereof are disclosed in a figure herein (e.g., FIG. 4) describing the operations of this process, such operations and sequencing are exemplary. Embodiments are well suited to performing various other operations or variations of the operations recited in the flowchart of the figure herein, and in a sequence other than that depicted and described herein.

As used in this application the terms controller, module, system, and the like are intended to refer to a computer-related entity, specifically, either hardware, firmware, a combination of hardware and software, software, or software in execution. For example, a module can be, but is not limited to being, a process running on a processor, an integrated circuit, an object, an executable, a thread of execution, a program, and or a computer. By way of illustration, both an application running on a computing device and the computing device can be a module. One or more modules can reside within a process and/or thread of execution, and a component can be localized on one computer and/or distributed between two or more computers. In addition, these modules can be executed from various computer readable media having various data structures stored thereon.

### Exemplary Audio Source Positioning Process Using Face Detection in Accordance with Embodiments of the Present Invention

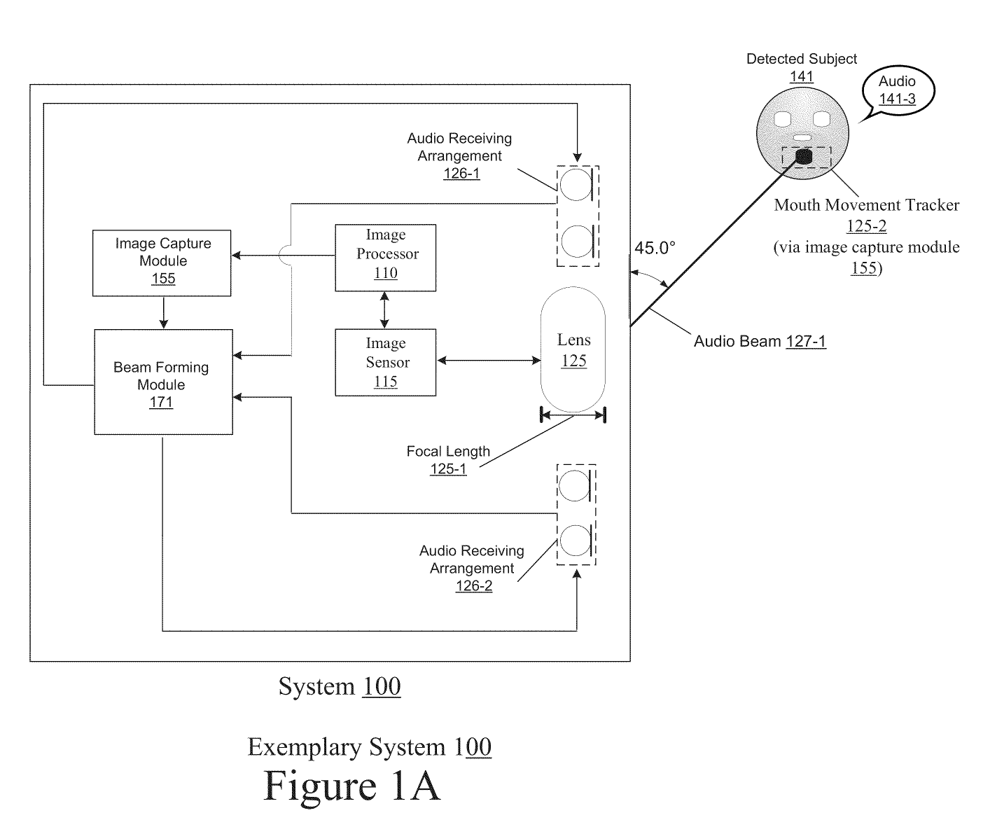

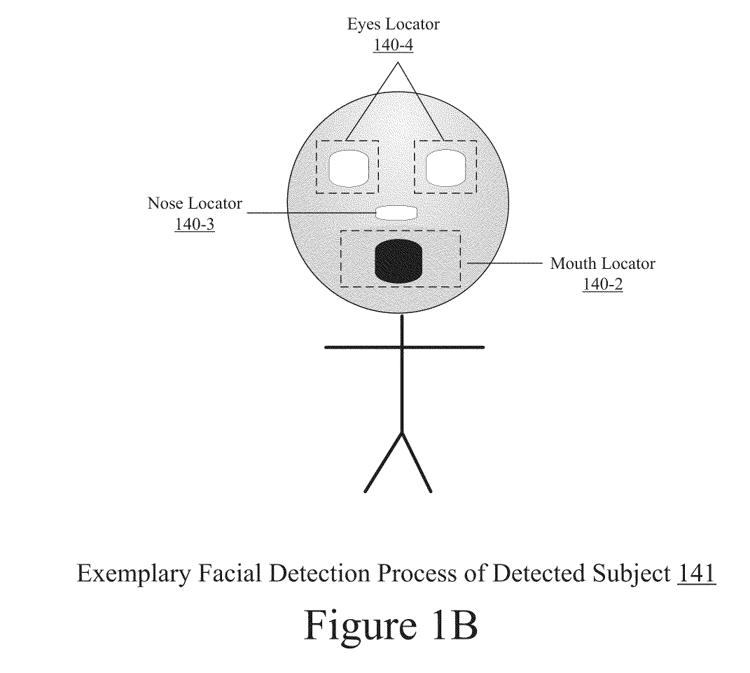

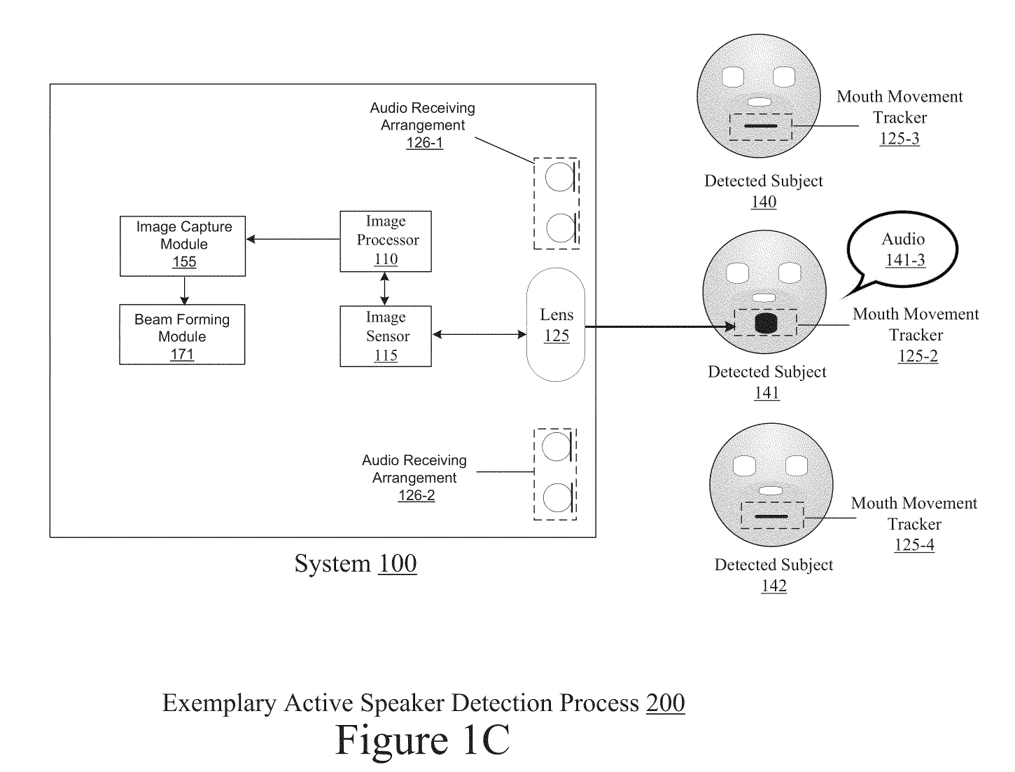

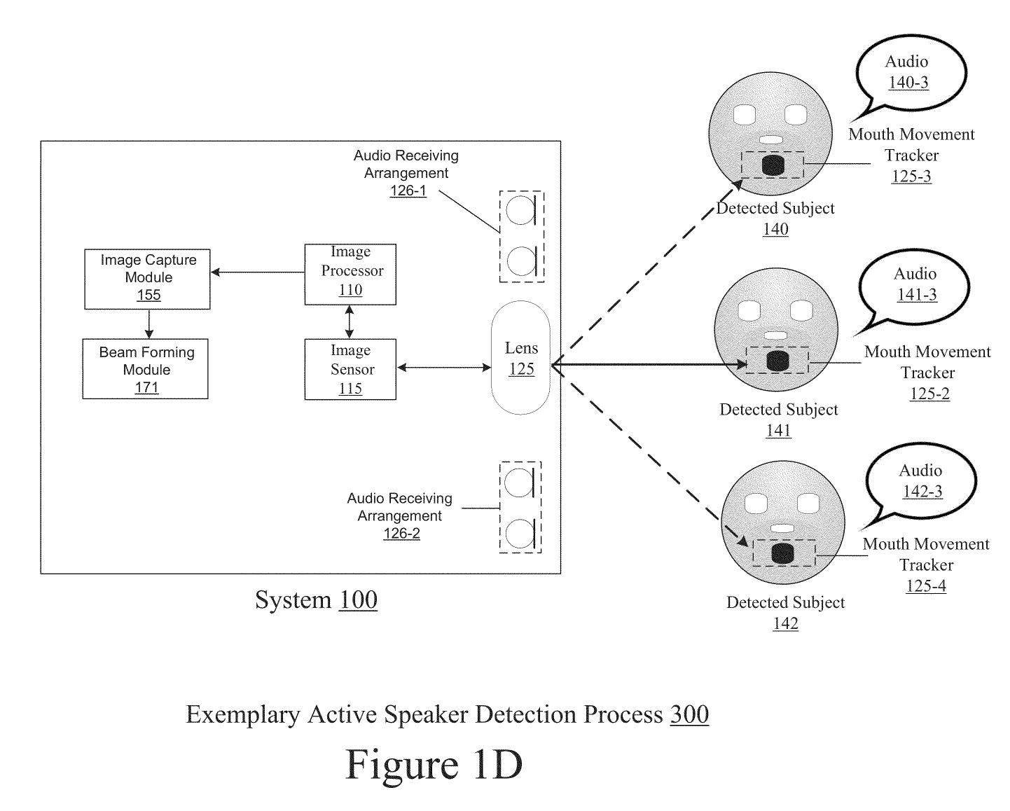

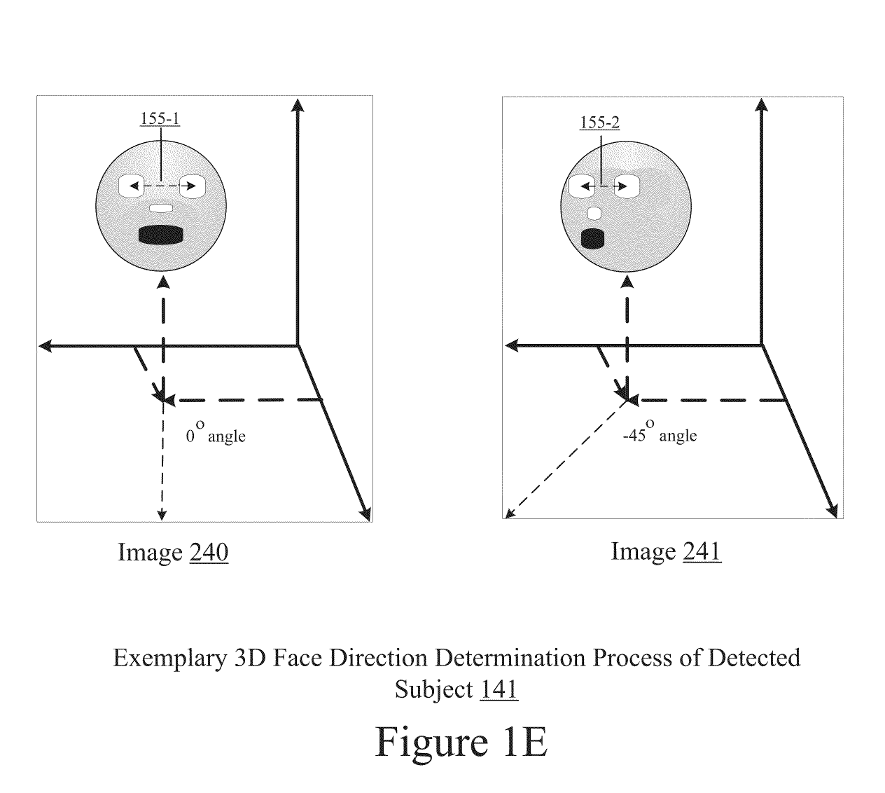

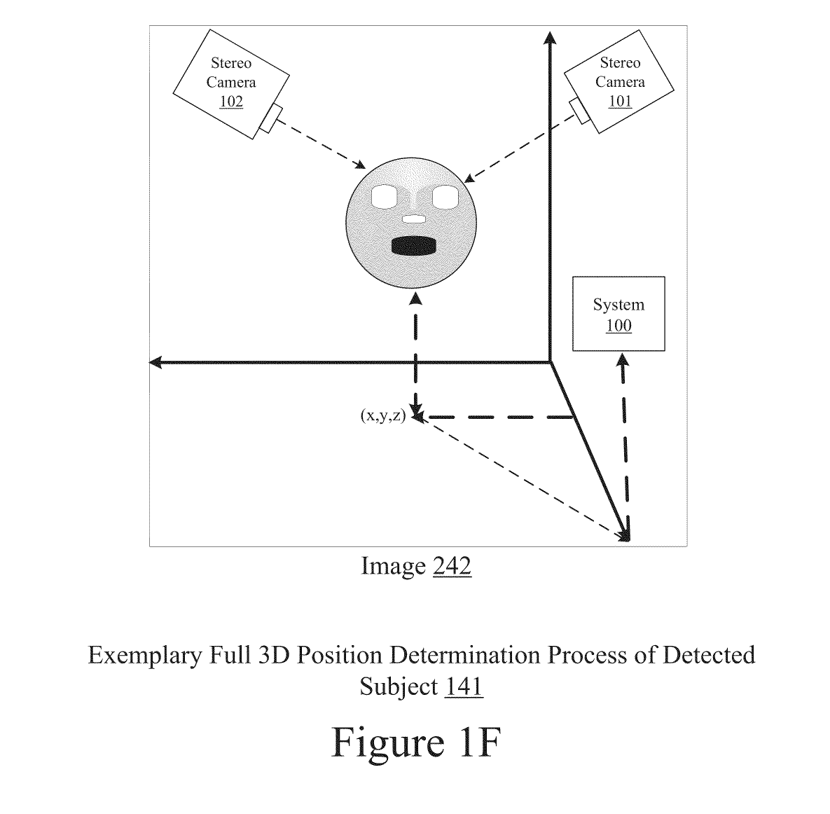

As presented in FIG. 1A, an exemplary system 100 upon which embodiments of the present invention may be implemented is depicted. System 100 can be implemented as, for example, a digital camera, cell phone camera, portable electronic device (e.g., audio device, entertainment device, handheld device), webcam, video device (e.g., camcorder) and the like. Components of system 100 may comprise respective functionality to determine and configure respective optical properties and settings including, but not limited to, focus, exposure, color or white balance, and areas of interest (e.g., via a focus motor, aperture control, etc.). Furthermore, components of system 100 may be coupled via internal communications bus and may receive/transmit image data for further processing over such communications bus.

According to the embodiment depicted in FIG. 1A, system 100 may capture scenes through lens 125, which may be coupled to image sensor 115. According to one embodiment, image sensor 115 may comprise an array of pixel sensors operable to gather image data from scenes external to system 100, such as detected subject 141 as well as the environment surrounding detected subject 141. As such, system 100 may capture light via lens 125 and convert the light received into a signal (e.g., digital or analog). Lens 125 may be placed in various positions along lens focal length 125-1. The image data gathered from these scenes may be stored within memory 150 for further processing by image processor 110 and/or other components of system 100. Although system 100 depicts only lens 125 in the FIG. 1A illustration, embodiments of the present invention may support multiple lens configurations and/or multiple cameras (e.g., stereo cameras).

Image data gathered from image sensor 115 may then be passed to image capture module 155 for further processing. Image sensor 115 may provide image capture module 155 with pixel data associated with a scene captured via lens 125. In one embodiment, image capture module 155 may analyze the acquired pixel data to detect the presence of faces that are captured within the scene using well-known face detection procedures. Using these procedures, image capture module 155 may gather data regarding the relative position, shape and/or size of various detected facial features such as cheek bones, nose, eyes, and/or the jaw bone. For instance, with reference to the embodiment depicted in FIG. 1B, image capture module 155 may be able to detect the eyes, nose and mouth of detected subject 141 captured within a scene using well-known face detection procedures capable of detecting those particular facial features (e.g., mouth locator 140-2 to locate the mouth of detected subject 141; nose locator 140-3 to locate the nose of detected subject 141; eyes locator 140-4 to locate the eyes of detected subject 141). As such, face detection provides information as to a subject of interest.

Furthermore, embodiments of the present invention may utilize face detection procedures which enable image capture module 155 to further recognize which of the detected subjects are actively speaking based on facial movements or gestures performed within a given scene. This may provide information to further define the subject of interest. With reference to the embodiment depicted in FIG. 1C, mouth movement trackers 125-3, 125-2, and 125-4 may be procedures utilized by image capture module 155 which are capable of tracking the lip movements of each subject detected (e.g., detected subjects 140, 141 and 142, respectively) within a given scene. As depicted within the scene captured in FIG. 1C, lip movements performed by detected subject 141 may alert image capture module 155 that detected subject 141 may be actively speaking (e.g., providing audio 141-3). As such, image capture module 155 may continue to track the mouth movements of detected subject 141 (e.g., mouth movement tracking 125-2) via lens 125 and gather image data regarding detected subject 141 for further processing by components of system 100. It should be appreciated that embodiments of the present invention are not limited to tracking mouth movements performed by a detected subject when determining whether a detected subject is actively speaking and may consider other facial movements or gestures performed by a detected subject that are consistent with making such determinations.

With reference to the embodiment depicted in FIG. 1D, embodiments of the present invention may be operable to select a subject (or multiple subjects of interest) upon the detection of multiple detected subjects actively speaking within a given scene. For instance, lip movements performed by detected subjects 140, 141 and 142 may alert image capture module 155 that these detected subjects may be actively speaking (e.g., each providing respective audio 140-3, 141-3 and 142-3). As such, image capture module 155 may continue to track the mouth movements of these detected subjects (e.g., mouth movement tracking 125-3, 125-2, 125-4) via lens 125. As depicted within the scene captured in FIG. 1D, the user may be given the option to select a particular detected subject that the user is interested in gathering audio exclusively from (depicted as arrows pointing to detected subjects 140, 141, and 142). Given the options available, the user may select detected subject 141 (illustrated with the solid arrow line) at which time image capture module 155 may gather image data regarding detected subject 141 for further processing by components of system 100. In one embodiment, the user may select all three detected subjects (e.g., detected subjects 140, 141 and 142) for further processing by components of system 100.

Additionally, embodiments of the present invention may utilize well-known facial recognition procedures which enable image capture module 155 to focus on specific detected subjects based on recognized facial data associated with that detected subject stored within a local data structure or memory resident on system 100 (e.g., facial data stored within memory 150). As such, embodiments of the present invention may be used for security purposes (e.g., granting specified detected subjects special permissions to perform a task or gain access to a particular item). Furthermore, embodiments of the present invention may also enable the user to manually focus on a particular detected subject, irrespective of the actions being performed by the detected subject or detected subjects of interest. For instance, in one embodiment, system 100 may be configured by the user to allow the user to manually focus on a particular detected subject using touch control options (e.g., “touch-to-focus”, “touch-to-record”) which may direct image capture module 155 to focus on a particular detected subject that the user selects through the system's viewfinder.

Furthermore, embodiments of the present invention may also be able to determine the facial angle (or “face direction”) of a detected subject of interest with respect to system 100 using pixel data acquired by components of system 100. For instance, according to one embodiment, image capture module 155 may be able to determine the direction of the detected subject's face within a 3D space based on pixel distances calculated between certain facial features detected (e.g., eyes) using the pixel data gathered via image sensor 115. Pixel distances calculated may be compared to predetermined threshold values which correlate to fixed facial angles relative to a specific location (e.g., relative to the position of system 100). These threshold values may be established based on a number of different detected subjects analyzed. Furthermore, these threshold values may be determined a priori through empirical data gathered or through calibration procedures using system 100.

For instance, when directly facing a camera, the distance between the eyes may yield a maximum eye separation distance for any given subject. As such, this value may serve as a reference point upon which other facial directions or angles or depth data with respect to the camera may be determined. Therefore, according to one embodiment, this distance may be set as a predetermined threshold value for use when determining the face direction of detected subjects captured in the future by the camera system. According to one embodiment, these values may be a priori data loaded within the memory of system 100 in factory.

Additionally, according to one embodiment, these values may be obtained through calibration procedures performed using system 100, in which system 100 captures an image (or multiple images) of one or more detected subjects and then subsequently analyzes them to determine threshold values. These images may be captured based on different lens perspectives by placing system 100 in various positions and capturing images of test subjects for calibration purposes. Furthermore, these threshold calculations may also include the physical characteristics of the lens itself (e.g., aperture of lens 125, position of lens 125 along focal length 125-1, zoom level used to capture images).

FIG. 1E depicts an embodiment of the present invention in which predetermined threshold values may be used to approximate the angle or “direction” at which the face of a detected subject of interest is positioned with respect to the lens of the camera system (e.g., lens 125 of system 100). With reference to the embodiment depicted in image 240 of FIG. 1E, image capture module 155 may calculate pixel distance 155-1 between the detected eyes of detected subject 141 when determining which direction detected subject 141's face is pointing towards. In one embodiment, distance 155-1 may include the distance between fixed points within the eyes of detected subject 141 (e.g., location of each eye's pupil). Distance 155-1 of image 240 may be calculated and then compared to predetermined threshold values correlating the pixel distances calculated to face direction angles with respect to system 100. As such, this comparison of distance 155-1 to predetermined threshold values may lead to the determination that the face direction of detected subject 141 is facing system 100 at an angle of 0 degrees.

With reference to the embodiment depicted in image 241 of FIG. 1E, image capture module 155 may calculate pixel distance 155-2 in a manner similar pixel distance 155-1. However, distance 155-2 of image 241 may represent a smaller pixel distance compared to distance 155-1. For instance, the eyes of subject 141 in this particular image may appear to be closer together compared to the maximal pixel distance determined within image 240. As such, image capture module may perform a computation and determine that the face direction of subject 141 is pointed at a −45 degree angle relative to system 100.

Additionally, embodiments of the present invention may also calculate the full 3D position of the detected subject within a given 3D space. According to one embodiment, stereoscopic cameras may be used to capture the 3D positioning (x,y,z) of detected subjects themselves. According to one embodiment, 3D positioning (x,y,z) of the detected subject may be calculated based on contrasts of the detected subject's face using available auto-focusing features of the system. As depicted in image 242 of FIG. 1F, stereo cameras 101 and 102 may assist image capture module 155 in calculating the full 3D position (x,y,z) of the detected subject 141. Furthermore, embodiments of the present invention may calculate both the face direction and the full 3D positioning of detected subjects simultaneously for use in making audio direction determinations, which will be described in further detail infra.

### Exemplary Audio Beam Formation and Adjustment Process Responsive to Determined Audio Source Positioning

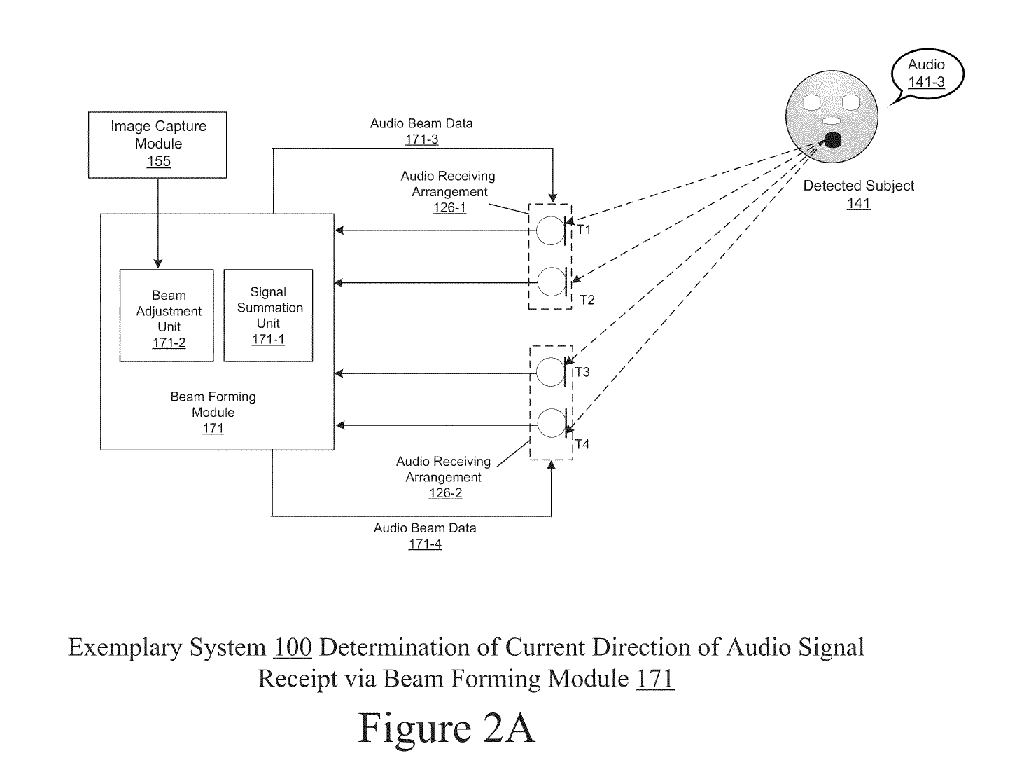

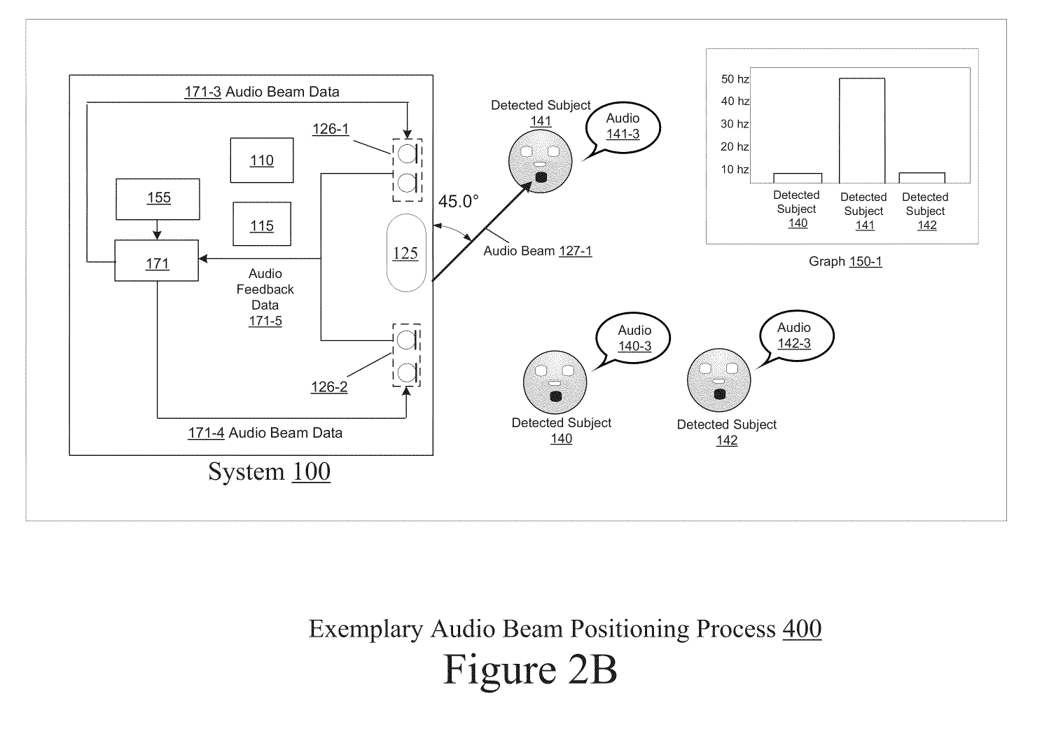

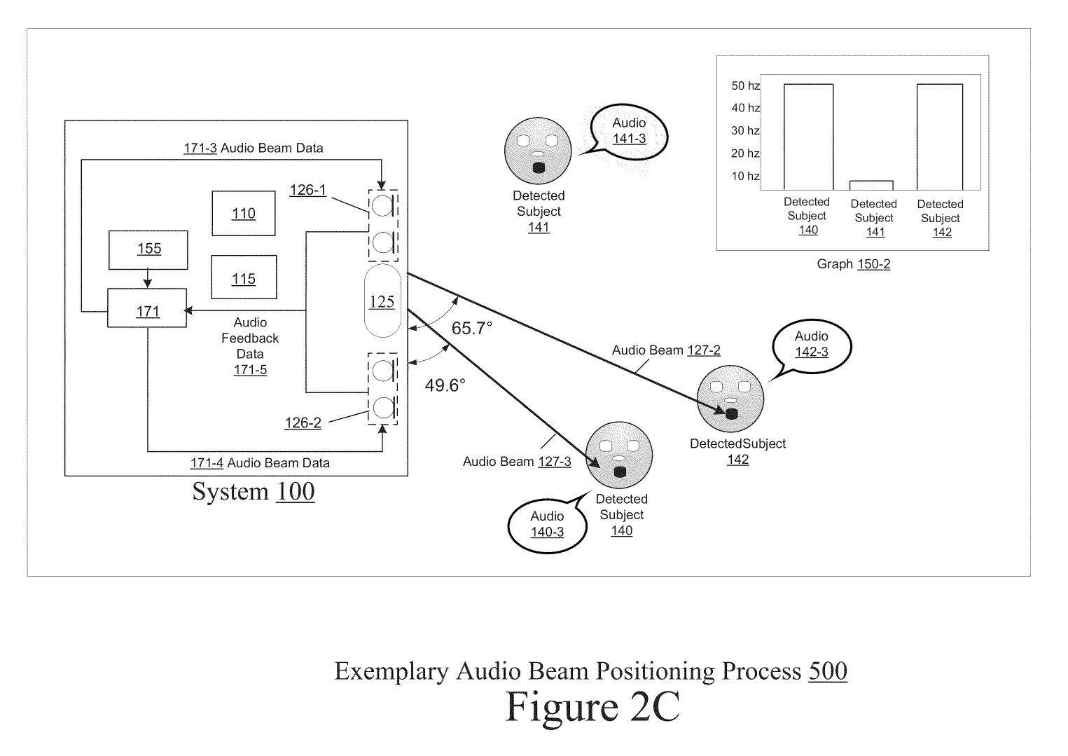

With reference to FIG. 2A, embodiments of the present invention may be operable to enhance the audio that originates from a given direction through the use of audio elements (e.g., microphones) located within system 100. For instance, audio receiving arrangements 126-1 and 126-2 may constitute a plurality of audio elements spatially arranged in a manner that enables system 100 to enhance the audio that originates from a given direction (e.g., an array of directional microphones and/or omnidirectional microphones). The arrangement of audio elements within system 100 may also enable the receipt of multiple different audio signals provided by multiple different audio sources. According to one embodiment, system 100 may use amplifiers as well as signal converters (e.g., ADCs) in processing the audio signals acquired via audio elements. It should be appreciated that embodiments of the present invention are not limited to the positioning and arrangement of audio elements as depicted in FIG. 2A and may be arranged in multi-dimensional and/or non-linear patterns. For instance, according to one embodiment, audio elements may be placed on separate sides of system 100 or arranged in a spherical pattern.

Beam forming module 171 may be operable to alter the phase and amplitude of audio signals received by audio elements within system 100. Beam adjustment unit 171-2 may produce isolated audio channels or “audio beams” through mathematical manipulation of incoming signal data such that gains and/or losses (e.g., signal attenuation) received by audio elements within system 100 are adjusted through constructive and/or destructive interference with respect to a particular pattern of audio signal acquisition. For instance, sound provided by detected subjects of interest may be of varying frequencies and may originate from varying distances relative to each audio element of system 100. As such, each audio element within audio receiving arrangements 126-1 and 126-2 may receive the same sound from a detected subject (e.g., audio 141-3 provided by detected subject 141) at different times (e.g., times T1-T4) and at varying degrees of signal strength based on each audio element's position relative to the detected subject.

According to one embodiment, beam adjustment unit 171-2 may mathematically incorporate signal delays for certain audio elements within audio arrangements 126-1 and 126-2 based on the current position (e.g., direction) of a detected subject of interest (e.g., face direction determined by image capture module 155). Beam adjustment unit 171-2 may recognize the physical locations of each audio element within system 100 (e.g., locations of each audio element within audio receiving arrangements 126-1 and 126-2). As such, beam adjustment unit 171-2 may amplify or attenuate signals to compensate for time variances in signal receipt among audio elements and produce a sound wave-front from a specific angle relative to system 100 such that when the audio signals are summed, the signal from that angle experiences constructive interference. In this manner, audio beams generated by beam forming module 171 may be electronically steered to any angle of incidence relative to system 100. Furthermore, beam forming module 171 may generate summed audio signal output based on the adjusted signal data received by each respective audio element within audio receiving arrangements 126-1 and 126-2 using signal summation unit 171-1. As such, audio beams may produce a resultant audio output that maximizes the signal-to-noise ratio with respect to the direction of detected subjects relative to system 100.

FIG. 2B illustrates a scenario involving 3 detected subjects actively speaking (e.g., detected subjects 141, 140 and 142) with two detected subjects (e.g., detected subjects 140 and detected subject 142) engaged in a discussion at such a distance from detected subject 141 that a user may have difficulty distinguishing the audio provided by detected subjects 140, 141 and 142 due to the noise created by the combined effect of audio 140-3, 141-3 and 142-3 being juxtaposed. As such, the user may be interested in gathering audio exclusively from detected subject 141 and filtering out other sources of audio (e.g., audio from detected subjects 140 and 142). Accordingly, beam forming module 171 may consider the angle at which the face of detected subject 141 is pointing towards relative to system 100 (e.g., as determined by image capture module 155). For example, beam forming module 171 may receive data from image capture module 155 indicating that the face of detected subject 141 may be at a 45 degree angle towards the left of lens 125. As a result, beam forming module 171 may position audio beam 127-1 at a 45 degree angle towards the left of lens 125. Furthermore, as illustrated in graph 150-1 of FIG. 2B, the combined effect of the constructive and destructive interference used to position audio beam 127-1 may enable the user to experience greater volume gains in the direction of detected subject 141 compared to detected subjects 140 and 142.

With reference to FIG. 2C, the user may now be interested in the conversation between detected subjects 140 and 142. Therefore, the user may wish to gather audio exclusively from those particular detected subjects and filter out other sources of audio (e.g., audio from detected subject 141). Beam forming module 171 may receive data from image capture module 155 indicating that the face of detected subject 140 is determined to be at a 49.6 degree angle towards the right of lens 125. Accordingly, beam forming module 171 may position audio beam 127-3 at a 49.6 degree angle towards the right of lens 125. Additionally, beam forming module 171 may also receive data from image capture module 155 indicating that the face of detected subject 142 is determined to be at a 65.7 degree angle towards the right of lens 125. Accordingly, beam forming module 171 may position audio beam 127-2 at a 65.7 degree angle towards the right of lens 125. Furthermore, as illustrated in graph 150-2 of FIG. 2C, the combined effect of the constructive and destructive interference used to position audio beams 127-3 and 127-2 may enable the user to now experience greater volume gains in the directions of detected subjects 140 and 142 as compared to detected subject 141. Additionally, FIG. 2C illustrates how embodiments of the present invention may utilize multiple audio beams simultaneously when isolating audio from multiple subjects of interest (e.g., subjects 140, 142). As such, a user may be able to gather audio exclusively from different subjects using separate isolated audio beams (e.g., audio beams 127-3, 127-2).

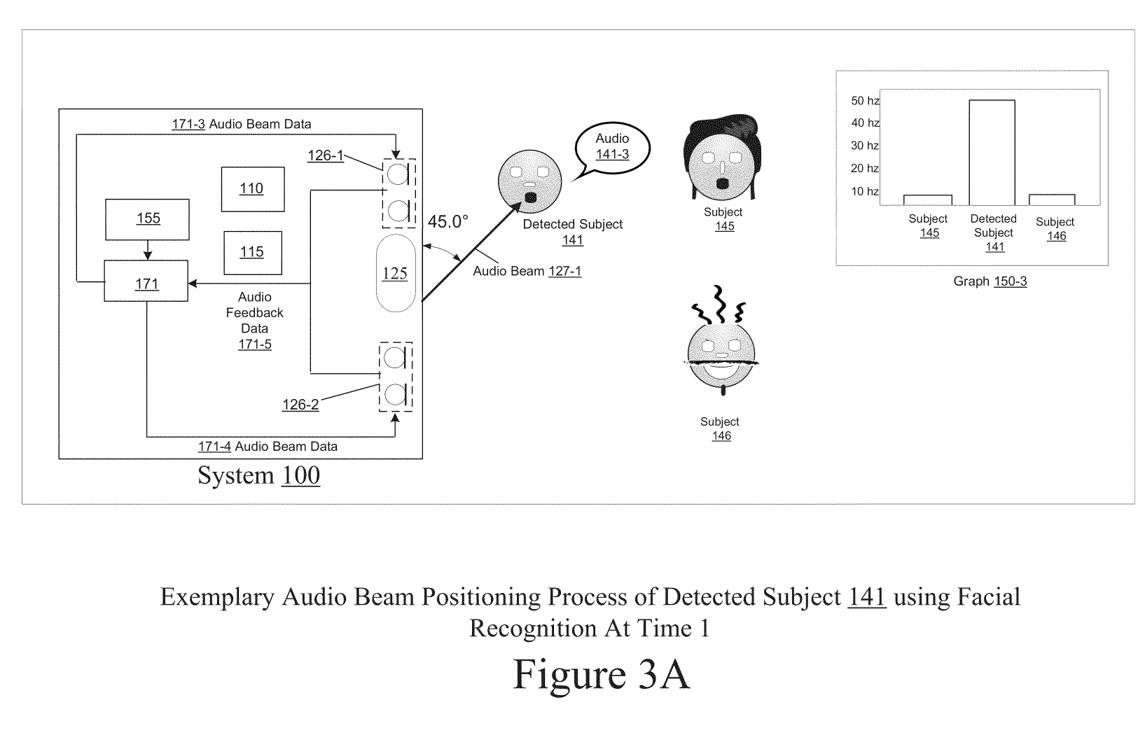

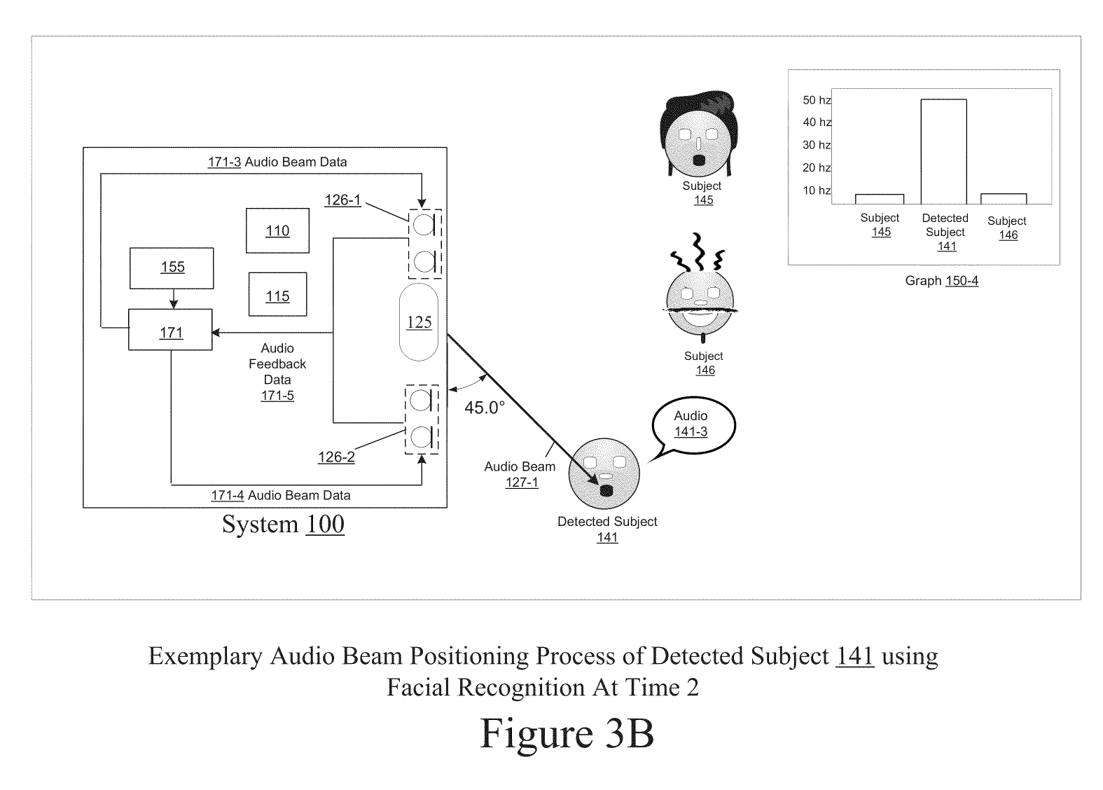

FIGS. 3A and 3B illustrate how embodiments of the present invention may dynamically alter the position of audio beams formed in real-time in response to detected subjects shifting their physical positions relative to system 100. FIGS. 3A and 3B depict detected subject 141 actively speaking while shifting positions relative to system 100 over a period of time. FIGS. 3A and 3B may be further used to demonstrate how embodiments of the present invention may utilize well-known facial recognition procedures which enable system 100 to capture audio exclusively from a specific subject. For instance, detected subject 141 may be recognized via image capture module 155 using recognized facial data associated with detected subject 141 stored within a local data structure or memory resident on system 100.

With reference to the FIG. 3A illustration, detected subject 141 may be recognized among various other subjects within a given scene (e.g., subjects 145 and 146) based on recognized facial data associated with detected subject 141 stored within a local data structure or memory 150 resident on system 100 using well-known facial recognition procedures. As such, image capture module 155 may be able to track detected subject 141 in real-time as detected subject 141 shifts positions relative to system 100. For instance, detected subject 141 may be initially positioned at a 45 degree angle towards the left of lens 125 when providing audio (e.g., audio 141-3) at Time 1. Accordingly, beam forming module 171 may position audio beam 127-1 at a 45 degree angle towards the left of lens 125 at Time 1. Furthermore, as depicted in graph 150-3 of FIG. 3A, the combined effect of the constructive and destructive interference used to position audio beam 127-1 may enable the user to experience greater volume gains in the direction of detected subject 141 compared to subjects 145 and 146.

With reference now to the FIG. 3B illustration, detected subject 141 may shift positions at Time 2 and now be positioned at 45 degree angle towards the right of lens 125 when providing audio (e.g., audio 141-3). Accordingly, beam forming module 171 may position audio beam 127-1 at a 45 degree angle towards the right of lens 125 at Time 2. Furthermore, as depicted in graph 150-4 of FIG. 3B, the combined effect of the constructive and destructive interference used to position audio beam 127-1 may enable the user to continue to experience similar levels of volume gain in the direction of detected subject 141 at Time 2 as in Time 1 in comparison to subjects 145 and 146.

FIG. 4 presents an exemplary process for enhancing audio of an object of interest in accordance with embodiments of the present invention.

At step 605, the camera system captures a scene to detect the faces of potential subjects of interests using the image capture module.

At step 610, a determination is made as to whether more than one face is detected. If more than one face is detected, then a further determination is made as to whether, of the faces detected, there is an actively speaking subject present, as detailed in step 615. If only one face is detected, then the image capture module calculates and passes coordinate data regarding the face direction of the detected subject to the audio controller module for further processing automatically without user intervention, as detailed in step 625.

At step 615, more than one face was detected and, therefore, the image capture module further determines whether, of the faces detected, there is an actively speaking subject present. If there is an actively speaking subject present, then the image capture module calculates and passes coordinate data regarding the face direction of the detected subject to the audio controller module for further processing automatically without user intervention, as detailed in step 625. If there are no actively speaking subjects present, then the image capture module passes coordinate data regarding the face direction of the subject (or subjects) manually selected by the user to the audio controller module for further processing, as detailed in step 620.

At step 620, there are no actively speaking subjects present, therefore, the image capture module passes coordinate data or direction regarding the face direction of the subject (or subjects) manually selected by the user to the beam forming module for further processing.

At step 625, there is an actively speaking subject present, therefore, the image capture module calculates and passes coordinate data or direction regarding the face direction of the detected subject to the beam forming module for further processing automatically without user intervention.

At step 630, the beam forming module receives data from the audio arrangement of the camera system and determines a current direction of audio signal receipt for the camera system.

At step 635, the beam forming module calculates audio beam positions based on calculations made by the image capture module at step 625 or step 620 in addition to the determinations made by the beam forming module at step 630.

At step 640, the beamforming module configures the audio arrangement of the camera system to position the audio beam in accordance with the determinations made at step 635.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service) may be accessible through a Web browser or other remote interface. Various functions described herein may be provided through a remote desktop environment or any other cloud-based computing environment.

The foregoing description, for purpose of explanation, has been described with reference to specific embodiments. However, the illustrative discussions above are not intended to be exhaustive or to limit the invention to the precise forms disclosed. Many modifications and variations are possible in view of the above disclosure. The embodiments were chosen and described in order to best explain the principles of the invention and its practical applications, to thereby enable others skilled in the art to best utilize the invention and various embodiments with various modifications as may be suited to the particular use contemplated.

Embodiments according to the invention are thus described. While the present disclosure has been described in particular embodiments, it should be appreciated that the invention should not be construed as limited by such embodiments, but rather construed according to the below claims.

What is claimed is:

1. An automated method of audio signal acquisition, said method comprising:
detecting a subject of interest within an environment using computer-implemented face detection procedures applied to image data captured by a camera system;
determining a face direction associated with said subject of interest relative to said camera system within a 3 dimensional space using said image data associated with said subject of interest; and
producing an output audio signal using an audio capture arrangement by focusing an audio beam of said audio capture arrangement in said face direction, wherein said output audio signal enhances audio originating from said subject of interest relative to other audio of said environment.

2. The method of audio signal acquisition as described in claim 1, wherein said detecting further comprises automatically selecting an actively speaking subject as said subject of interest from a plurality of subjects based on recorded images of facial movements performed by said actively speaking subject.

3. The method of audio signal acquisition as described in claim 1, wherein said face direction comprises an angle and a depth.

4. The method of audio signal acquisition as described in claim 3, wherein said determining a face direction further comprises using camera system focusing features to locate said subject of interest.

5. The method of audio signal acquisition as described in claim 1, wherein said determining a face direction further comprises determining a 3 dimensional coordinate position for said subject of interest using stereoscopic cameras.

6. The method of audio signal acquisition as described in claim 1, wherein said focusing further comprises electronically steering said audio beam to filter out directionally inapposite audio received relative to said face direction using beamforming procedures.

7. The method of audio signal acquisition as described in claim 1, wherein said audio capture arrangement comprises an array of microphones.

8. A system of audio signal acquisition, said system comprising:
an image capture module operable to detect a subject of interest using computer-implemented face detection procedures applied to image data, wherein said image capture module is operable to determine a face direction associated with said subject of interest relative to a camera system within a 3 dimensional space using said image data associated with said subject of interest;
a directional audio capture arrangement operable to produce an output audio signal using a directional audio beam; and
a beamforming module operable to direct said audio beam in said face direction, wherein said audio signal enhances audio originating from said subject of interest relative to other audio.

9. The system of audio signal acquisition as described in claim 8, wherein said image capture module is further operable to automatically select an actively speaking subject as said subject of interest from a plurality of subjects based on recorded images of facial movements performed by said actively speaking subject.

10. The system of audio signal acquisition as described in claim 8, wherein said face direction comprises an angle and a depth.

11. The system of audio signal acquisition as described in claim 10, wherein said image capture module is further operable to determine said depth using camera system focusing features to focus on said subject of interest.

12. The system of audio signal acquisition as described in claim 8, wherein said image capture module is further operable to determine a 3 dimensional coordinate position for said subject of interest using stereoscopic cameras.

13. The system of audio signal acquisition as described in claim 8, wherein said directional audio capture arrangement is further operable to filter out directionally inapposite audio received relative to said face direction using beamforming procedures.

14. The system of audio signal acquisition as described in claim 8, wherein said directional audio capture arrangement comprises an array of microphones.

15. A method of audio signal acquisition, said method comprising:
detecting a plurality of subjects of interest using computer-implemented face detection procedures applied to image data;
determining a respective face direction associated with each subject of said plurality of subjects of interest relative to a camera system within a 3 dimensional space using said image data associated with said plurality of subjects of interest; and
producing a respective output audio signal for each subject of said plurality of subjects of interest using a directional audio capture arrangement by focusing a plurality of audio beams in said face directions of said plurality of subjects of interest, wherein said audio output signals enhance audio originating from said plurality of subjects of interest relative to other audio.

16. The method of audio signal acquisition as described in claim 15, wherein said detecting further comprises automatically selecting an actively speaking subject as said subject of interest based on recorded images of facial movements performed by said actively speaking subject.

17. The method of audio signal acquisition as described in claim 15, wherein said detecting further comprises automatically detecting said plurality of subjects of interest using computer-implemented facial recognition procedures that recognize eye and nose positions.

18. The method of audio signal acquisition as described in claim 15, wherein said determining further comprises using camera system focusing features to locate said plurality of subjects of interest.

19. The method of audio signal acquisition as described in claim 15, wherein said determining a face direction further comprises determining a respective 3 dimensional coordinate position for each subject of said plurality of subjects of interest using stereoscopic cameras.

20. The method of audio signal acquisition as described in claim 15, wherein said focusing further comprises electronically steering said plurality of audio beams to filter out directionally inapposite audio received relative to said respective face direction of each subject of said plurality of subjects of interest using beamforming procedures.

21. The method of audio signal acquisition as described in claim 15, wherein said directional audio capture arrangement comprises an array of microphones.
